(19) United States
(12) Patent Application Publication
(10) Pub. No.: US 2008/0060212 A1
(43) Pub. Date: Mar. 13, 2008

(54) Process for Drying Plastic Materials in Granule Form with the Use of Microwaves and Drying System Operating According to the Process

(76) Inventor: Gianfranco Cattapan, Campodarsego (IT)

Correspondence Address: RATNERPRESTIA, P O BOX 980, VALLEY FORGE, PA, 19482-0980, US

(21) Appl. No.: 11/628,285

(22) PCT Filed: Jan. 3, 2005
(86) PCT No.: PCT/EP05/00023

§ 371 Date: Nov. 30, 2006

(30) Foreign Application Priority Data
Jun. 1, 2004 (IT) PD2004A 000143

(51) Int. Cl. F26B 3/347

(52) U.S. Cl. 34/265; 34/168; 34/259

(57) ABSTRACT

A process for the drying of plastics materials in granule form includes a step of irradiation of the granules with microwaves, during which the granules are conveyed by gravity, inside a hopper, through the field of action of a microwave source. A drying system operating in accordance with the process is also described.

This application is a U.S. National Phase Application of PCT International Application PCT/EP2005/000023 which is incorporated by reference herein.

### TECHNICAL FIELD

The present invention relates to a process and a system of drying plastics materials in granule form with the use of microwaves.

### BACKGROUND OF THE INVENTION

In the technical field to which the invention relates, the drying of plastic materials in granule form with the use of microwaves is known. However, since this operation is typically carried out immediately upstream of the step for the extrusion and moulding of the plastics material, in order to ensure the quality standards of the final product, the properties of the granules, for example in terms of residual moisture and of temperature, must be as uniform and constant as possible.

To respond to this requirement, known systems generally provide for continuous stirring of the granules, whilst they are subjected to irradiation with microwaves, with the use, for example, of blade stirrers or vibrating systems. However, since these mechanisms comprise many mechanical parts that are in motion, their presence complicates the design and operative control of these systems, at the same time increasing their overall cost.

### BRIEF SUMMARY OF THE INVENTION

The problem underlying the present invention is that of providing a process of drying plastic materials in granule form with the use of microwaves, as well as a system operating in accordance with the process, which are designed structurally and functionally to overcome the limitations set out above with reference to the prior art mentioned.

This problem is solved by the present invention by means of a drying process and a system in which the granules of plastic materials and hopper are provided so that the granules are conveyed along the hopper, through the microwave field, by gravity.

### BRIEF DESCRIPTION OF THE DRAWINGS

The characteristics and the advantages of the invention will become clearer from the detailed description of some preferred embodiments thereof which are described by way of non-limiting example with reference to the appended drawings, in which:

FIG. 1 is a schematic, sectioned front elevational view of a first drying system realized in accordance with the present invention,

FIG. 2 is a schematic view of the system of FIG. 1, sectioned along line II-II,

FIG. 3 is a schematic, sectioned front elevational view of a second drying system realized in accordance with the present invention, and

FIG. 4 is a schematic view of the system of FIG. 3, sectioned along line IV-IV.

### DETAILED DESCRIPTION OF THE INVENTION

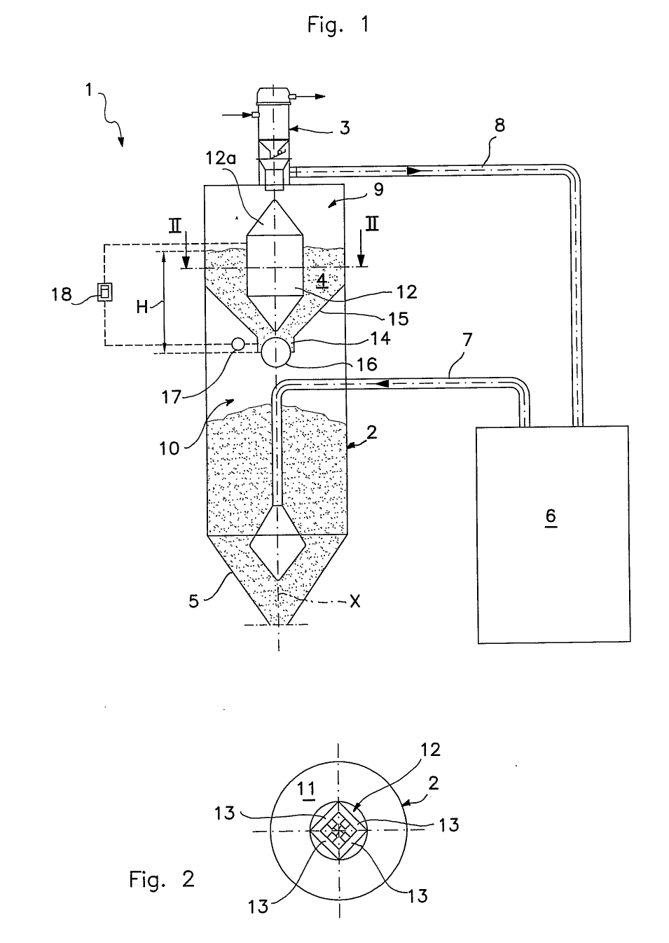

In FIGS. 1 and 2, a first embodiment of a system for drying plastic materials in granule form, realized in accordance with the present invention, is generally indicated 1.

The system 1 comprises a hopper, indicated 2, on the top of which is mounted a system 3 for supplying granules 4 of plastic material, for example granules of polyethylene terephthalate (PET), and the bottom 5 of which is connected to an injection and moulding press which is conventional and is therefore not shown in the drawings.

The hopper 2 is also connected to an air or gas moisture-removal unit, generally indicated 6, which comprises a supply duct 7 opening in the hopper 2 in the region of the bottom 5 and an outlet duct 8 opening at the top of the hopper 2.

The hopper 2 preferably has a circular cross-section with a diameter of between 500 and 1300 mm.

An irradiation section 9 and a heating section 10 for the granules 4 are defined in the hopper 2, along the vertical axis X thereof, and are arranged vertically above one another.

A microwave source 12 for subjecting the granules 4 passing through the section 9 to microwave irradiation is mounted in the irradiation section 9, extending along the axis X. It will be noted that a substantially toroidal-shaped passageway 11 is thus defined for the granules 4 between the source 12 and the walls of the hopper 2. To promote the uniform arrangement of the granules around the source 12, the source may advantageously be provided with a conical cover 12a at its top.

The source 12 comprises a plurality of emitters 13 arranged at angular intervals about the axis X in order to emit microwaves radially towards the walls of the hopper 2 so that the field of action of the source covers the entire cross-section of the hopper 2.

The radial distance between the microwave source and the hopper walls is preferably substantially constant and between 100 and 350 mm.

Advantageously, a constriction 14 is arranged between the irradiation section 9 and the heating section 10 and below the microwave source 12 and is defined by a plate 15 with an inverted-cone-shaped profile, open in the centre, through which the granules 4 are conveyed. The constriction 14 enables a “head” of granules of plastics material to be created in the irradiation section 9, irrespective of the quantity of granules present in the underlying heating section 10, so that the operative parameters of the two sections can be determined independently of one another.

Means 16 for regulating the flow-rate of the granules are also provided between the irradiation section 9 and the underlying heating section 10, in the region of the constriction 14, to enable the time spent by the granules 4 in the irradiation section 9 to be varied.

The regulation means 16 may, for example, comprise a star-type rotary valve or another element which can vary the aperture of the constriction 14.

Sensor means 17 for detecting the residual moisture of the granules 4 are also fitted in the region of the constriction 14, enabling control means 18 for controlling the power of the microwave source 12 to regulate the power of the radiation emitted.

The system 1 operates as follows.

The granules 4 of plastics material are admitted to the irradiation section 9 from the top of the hopper 2 by means of the supply system 3 and are arranged, by falling, in an annular arrangement around the microwave source 12, defining a head H of plastics material relative to the constriction 14 for the discharge of the granules to the heating section.

The height H of the head can be regulated suitably by the regulation means 16 (as well as by the supply system 3) in dependence on the time set for the exposure of the granules to the microwaves. This time will generally vary, up to a maximum of 60 min., according to the characteristics of the granules to be dried.

In the irradiation section 9, the granules 4 fall gradually and uniformly around the microwave source 12 simply by gravity, remaining exposed to its field of action for the desired time. Under the effect of the microwaves, the moisture present in the granules 4 is extracted and is then finally removed from the hopper 2 by the effect of the dehumidified gaseous stream which is supplied continuously from the duct 7 and flows as a counter-current through the granules 4 towards the outlet duct 8.

It will be noted that the short distance between the microwave source 12 and the walls of the hopper 2 causes the field of action of the microwaves to extend throughout the radial extent of the section through which the granules pass so as to avoid (or at least greatly limit) the effect of radial attenuation of the power of the microwaves.

In the irradiation section 9, moisture is thus removed from the granules until the residual moisture is reduced substantially to the final levels required by the drying process as a whole, for example, in the case of PET granules, to about 30 ppm. Moreover, the granules are also partially heated by the combined action of the microwaves and of the dehumidified gaseous stream, to reach a temperature of about 80-120° C. at the input to the heating section 10.

In the region of the constriction 14, the residual moisture of the granules is measured by the sensor means 17 which indicate that value to the control means 18 of the source which consequently vary the power of the source 12 if necessary.

Downstream of the constriction 14 and of the regulation means 16, the granules are admitted, again by falling, to the heating section 10, in which, during their descent towards the bottom 5, they are in contact with the hot and dehumidified gaseous (air) stream admitted from the supply duct 7. In this section, by virtue of contact with the hot air, the granules are brought to the desired final temperature (180-220° C.) for admission to the injection and moulding press disposed downstream of the hopper 2.

It will be noted that, in this section, the gaseous stream has the sole purpose of heating the plastics material, since the granules have already undergone moisture removal whereas, in the irradiation section 9, the gaseous stream has the function of absorbing the moisture extracted from the granules and removing it from the system. This advantageously enables a much smaller quantity of air to be used than in conventional drying systems with air alone. At the same time, in comparison with known microwave drying systems, the system retains substantial simplicity of construction and control which makes use of the gravity falling mechanisms that are typical of air-only drying systems.

The uniformity of exposure to the microwaves to which the granules are subjected is ensured by the system of falling by gravity through the irradiation section of the hopper which provides homogeneous average times spent therein.

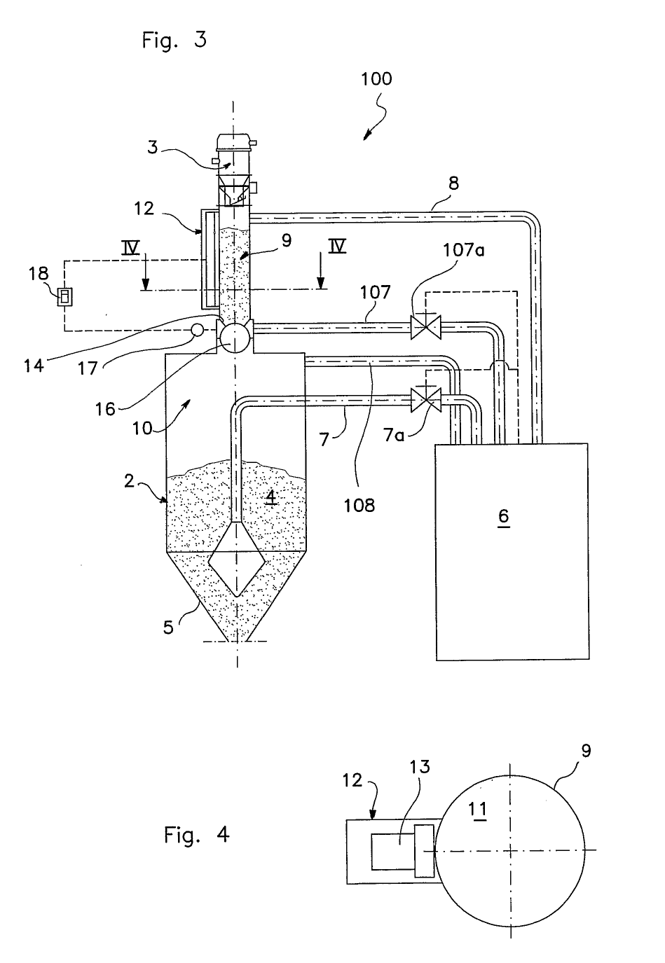

In FIGS. 3 and 4, a second system for drying plastics materials in granule form with the use of microwaves according to the present invention, in which details similar to those of the system described in the previous embodiment are indicated by the same reference numerals, is generally indicated 100.

The system 100 differs from the system 1 in that the microwave source 12 is disposed outside the irradiation section 9 of the hopper 2. In this case, however, the diameter of that section of the hopper is smaller and of suitable dimensions not to give rise to non-homogeneity of the microwave irradiation. In particular, the diameter of the irradiation section 9, like the radial distance between the microwave source and the walls of the hopper of the system 1, will be between 100 and 350 mm.

The source 12 of the system 100 is arranged against a wall of the hopper 2 and extends along the axial extent thereof in order to radiate microwaves towards the interior of the hopper in which the granules 4 are present and are conveyed by gravity towards the underlying heating section 10. In comparison with the system of the previous embodiment, this configuration permits easier control and maintenance of the source 12 and the system as a whole is also more economical. On the other hand, the system 1 enables greater flow-rates of granules to be treated for a given vertical extent of the hopper 2.

The system 100 also provides for a dual supply of hot and dehumidified air output from the dehumidification unit 6 towards the hopper 2. The first supply is located, as in the system 1, in the region of the bottom 5 of the hopper 2 and is performed by means of a first supply duct 7 in which means 7a may be mounted for regulating the flow-rate of the hot and dehumidified air.

The second supply is performed by means of a second supply duct 107 which enters the hopper 2 at the bottom of the irradiation section 9. Moreover, means 107a for regulating the flow-rate of hot and dehumidified air output from the unit 6 may also be mounted on the second supply duct 107.

The flow-rates and properties (in terms of temperature and moisture content) of the air streams admitted to the heating and irradiation sections 10 and 9 can thus be varied with greater freedom. The flow-rate of air which flows through the irradiation section 9 will thus be given by the sum of the flow-rates of air admitted by the ducts 7 and 107 and its temperature and humidity characteristics will be intermediate the characteristics of the air admitted by the duct 107 and the air output from the section 10.

If, for example, the means 16 for regulating the flow-rate of the granules do not allow the gaseous stream to pass freely from the heating section 10 to the irradiation section 9, a second outlet duct 108 may be provided for conveying the hot and dehumidified air admitted to the heating section 10 back to the dehumidification unit 6.

In this case, the gaseous streams supplied to the two sections of the hopper can be regulated wholly independently of one another.

The operation of the system 100 is just the same as that of the system 1 of the previous embodiment.

A variant of the system 1 provides for the system 1 to be equipped with the dual system for the supply of hot and dehumidified air described above with reference to the system 100 and, correspondingly, a variant of the system 100 provides for a single supply of hot and dehumidified air to the hopper 2.

The present invention thus solves the problem discussed above with reference to the prior art mentioned, at the same time offering many further advantages, amongst which is a substantial reduction in the production and running costs of the drying system using microwaves.

1. A process of drying plastics materials in granule form, comprising a step of irradiation of the granules with microwaves, during which the granules are conveyed, inside a hopper, through the field of action of a microwave source in order to extract moisture that is present in the granules to be dried, and the granules are conveyed through the field, along the hopper, by gravity.

2. The process according to claim 1 in which a dehumidified gaseous stream is caused to flow as a counter-current between the granules in order to remove the moisture that has been extracted from the granules by means of the microwaves.

3. The process according to claim 1 in which, after the irradiation step, a step is provided for heating of the granules by means of a hot and dehumidified gaseous stream which is caused to flow as a counter-current between the granules.

4. The process according to claim 3 in which the hot and dehumidified gaseous stream output from the granule-heating step is caused to flow as a counter-current between the granules in the irradiation step.

5. The process according to claim 4 in which, before the hot and dehumidified gaseous stream enters the irradiation step, it is combined with a second dehumidified gaseous stream.

6. The process according to claim 1 in which the granules are conveyed around the microwave source by gravity.

7. The process according to claim 1 in which the time spent by the granules in the field of action of the microwave source is regulated in dependence on the residual moisture of the granules upon completion of the irradiation step.

8. The system for drying plastics materials in granule form, comprising a hopper to which the granules are admitted and a source of microwaves for removing moisture from the granules when they are conveyed through a field of action of the source inside the hopper, and the granules and hopper provided so that the granules are conveyed along the hopper, through the field of action, by gravity.

9. The system according to claim 8 in which there are defined in the hopper an irradiation section in which the microwave source is positioned and a granule-heating section disposed vertically below the irradiation section.

10. The system according to claim 9 in which means for regulating the granule flow-rate are provided between the irradiation section and the heating section.

11. The system according to claim 10 in which the means for regulating the granule flow-rate are controlled in dependence on a preset time spent by the granules inside the irradiation section.

12. The system according to claim 8 in which means are provided for controlling the power of the microwave source.

13. The system according to claim 12 in which the control means are subservient to sensor means for detecting the residual moisture in the granules.

14. The system according to claim 13 in which the residual-moisture sensor means are positioned between the irradiation section and the heating section.

15. The system according to claim 9 in which a first supply duct for admitting a hot and dehumidified gaseous stream into the hopper opens into the heating section and a first outlet duct for removing the gaseous stream from the hopper after it has been caused to flow as a counter-current between the granules opens in the irradiation section.

16. The system according to claim 15 in which a second supply duct for admitting a dehumidified gaseous stream to the hopper opens at the bottom of the irradiation section.

17. The system according to claim 16 in which a second outlet duct for removing the hot and dehumidified gaseous stream from the heating section opens in the heating section.

18. The system according to claim 15, in which means for regulating the flow-rate of the gaseous streams are provided in the supply duct.

19. The system according to claim 8 in which the microwave source is disposed inside the hopper in a manner such that the granules are conveyed around the source by gravity.

20. The system according to claim 19 in which the microwave source comprises a plurality of emitters which are arranged to emit microwaves in radial directions so as to cover the entire cross-section of the hopper.

21. The system according to claim 20 in which the microwave source extends along a vertical axis (X) of the hopper.

22. The system according to claim 19 in which the hopper has a circular cross-section and the microwave source is disposed substantially in the centre of the cross-section.

23. The system according to claim 22 in which the distance between the source and the walls of the hopper is between 100 and 350 mm.

24. The system according to claim 8 in which the microwave source is disposed outside the hopper.

25. The system according to claim 24 in which the microwave source is arranged against a wall of the irradiation section of the hopper and extends along the axial extent thereof.

26. The system according to claim 25 in which the hopper has a diameter of between 100 and 350 mm in the irradiation section.

27. The system according to claim 16 in which means for regulating the flow-rate of the gaseous streams are provided in the supply ducts.

28. The system according to claim 17 in which means for regulating the flow-rate of the gaseous streams are provided in the supply ducts.
